(19) United States
(12) Patent Application Publication
(10) Pub. No.: US 2006/0272561 A1
(43) Pub. Date: Dec. 7, 2006

(54) Deposition apparatus

(76) Inventors: Kyu-Baik Chang, Hwaseong-si (KR); Tai-Kyung Kim, Anyang-si (KR); Jae-Hyun Han, Hwaseong-si (KR); Won-Young Chung, Hwaseong-si (KR); Hyung-Kyu Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/445,346

(22) Filed: Jun. 2, 2006

(30) Foreign Application Priority Data
Jun. 3, 2005 (KR) 2005-47870

(51) Int. Cl. A01C 7/00; A01C 9/00

(52) U.S. Cl. 111/183

(57) ABSTRACT

A deposition apparatus may include a deposition-preventing member for preventing deposition of process gas on a portion of substrate removeably arranged inside a processing chamber. The deposition-preventing member may include a fixing member for fixing the deposition preventing member to a fixed body of the processing chamber, a blocking member for blocking the to-be-blocked portion of the substrate to be processed, and a guiding member for guiding fluid and particles out from the processing chamber, the guiding member may include a guiding surface that prevents a vortex from forming on the deposition-preventing member when fluid and particles are flowing out of the processing chamber.

### BACKGROUND OF THE INVENTION

1. Field of the Invention

The present invention relates to an apparatus employable for manufacturing semiconductor substrates. More particularly, aspects of the invention relate to a deposition apparatus employable for forming a thin film on a semiconductor substrate.

2. Description of the Related Art

Semiconductor chips are generally manufactured from a semiconductor substrate, e.g. a wafer, by iteratively performing deposition, photolithography, etching and/or polishing processes. A deposition apparatus may include a chuck on which a wafer is loaded in a processing chamber. A thin film, e.g., of aluminum or tungsten, may be unintentionally formed at an edge of a wafer during a deposition process. Such a thin film formed at the edge, e.g., beveled portion, may generate undesired particles when, e.g., the wafer is, e.g., being transferred or polished. Therefore, a deposition-preventing member may be provided at the edge of a wafer for reducing and/or preventing formation of such a thin film on the edge of the wafer during processing. A base may be provided around, e.g., the circumference, of the deposition-preventing member to support the deposition-preventing member.

During processing, fluid inside a processing chamber may flow outward, e.g., from a central portion of a wafer W toward a side wall of the processing chamber. More particularly, fluid may flow over and/or beyond the base toward an exhaust pipe provided at, e.g., a sidewall of the processing chamber. A whirlpool or vortex may form as such fluid flows toward the outside. For example, a whirlpool or vortex may be formed at a boundary between, e.g., a top surface of a fixed body and the base, which may be arranged on the fixed body. Such a whirlpool or vortex may prevent the smooth flow of the fluid.

Process gas and/or reactive products may accumulate on a top surface of the base. During a subsequent processing step, such remaining materials, e.g., gas and/or reactive products, may develop into particles and negatively impact the subsequent process(es).

In an effort to remove such remaining materials, after a processing step, e.g., a deposition, is completed, a cleaning process may be performed to clean the inside of the processing chamber. However, even during such cleaning processes, a formed whirlpool or vortex may from and prevent smooth flow of materials, e.g., a gas, used during the cleaning process. Some of the cleaning material(s) may also accumulate at, e.g., the boundary between the fixed body and the base. Thus, the cleaning material(s), e.g., gas, may remain inside the processing chamber.

### SUMMARY OF THE INVENTION

The present invention is therefore directed to apparatuses employable for manufacturing semiconductor substrates, which substantially overcome one or more of the problems due to the limitation and disadvantages of the related art.

It is therefore a feature of an embodiment of the present invention to provide a deposition apparatus employable for forming a thin film on a semiconductor substrate that has a structure that reduces and/or prevents formation of a vortex and the development and/or accumulation of undesired materials, e.g., gas, particles, etc., on, e.g., a deposition-preventing member.

At least one of the above and other features and advantages of the present invention may be realized by providing a deposition apparatus for processing a substrate removeably supplied to the deposition apparatus, the substrate including a to-be-blocked portion that is to be blocked during a deposition process, the deposition apparatus including a processing chamber to which an exhaust pipe is connected, a supporting member arranged inside the processing chamber for holding the substrate, a gas supply member for supplying process gas to the substrate held by the supporting member, a deposition-preventing member arranged to cover the to-be-blocked portion of the substrate to block the process gas from being supplied to the to-be-blocked portion of the substrate, and a fixing member disposed to support the deposition-preventing member, wherein a top surface of the fixing member includes a guide surface that extends substantially along an angle relative to a bottom wall of the processing chamber and such that an inner portion of the guide surface is closer to the bottom wall of the processing chamber than an outer portion of the guide surface.

The guide surface may be inclined. The guide surface may include plurality of stepped surfaces. The guide surface may be curved. The fixing member may be spaced apart from a sidewall of the processing chamber to define a path, between the sidewall of the processing chamber and the fixing member, for fluid, which is supplied to or generated during inside the processing chamber during processing, to flow to the exhaust pipe. The deposition-preventing member may include a blocking portion and a support portion and the support portion may include a plurality of protrusions extending outwardly from an outer surface of the blocking portion, and the fixing member may include a base that may include a supporting groove for respectively receiving the protrusions. The deposition-preventing member may include a blocking portion and a support portion and the support portion may include a plurality of protrusions extending outwardly from an outer surface of the blocking portion, and the fixing member may include a base portion and a guide portion that together define a plurality of supporting grooves for respectively receiving the protrusions, wherein the guide portion is arranged on the base portion and the guide portion may include the guide surface.

The guide portion may be attachable to and detachable from the base portion. The deposition-preventing member and the fixing member may be substantially ring-like members. The fixing member may surround sides of the supporting member such that a surface of the supporting member on which the substrate is arranged is exposed and capable of receiving the process gas. The deposition-preventing member may block an edge portion of the substrate being processed during the deposition process.

At least one of the above and other features and advantages of the present invention may be separately realized by providing an apparatus for depositing a thin-film on a semiconductor substrate removeably supplied to the apparatus, the substrate including a to-be-blocked portion that is to be blocked during formation of the thin-film, the apparatus including a processing chamber to which an exhaust pipe is connected, a supporting member disposed inside the processing chamber for holding the substrate, a gas supply member for supplying process gas onto the substrate held by the supporting member, a preventing member arranged to cover the to-be-blocked portion of the substrate to prevent the process gas from being supplied to the to-be-blocked portion of the substrate, a fixed body disposed between the supporting member and a sidewall of the processing chamber, the fixed body being spaced apart from the sidewall of the processing chamber and defining a path, between the sidewall of the processing chamber and the fixed body, along which fluid supplied to or generated inside the processing chamber may flow to be exhausted, the fixed member extending further from a bottom wall of the processing chamber than the preventing member and the fixed member including a projecting support portion, and a fixing member arranged on the projecting support portion, the fixing member including a base portion for supporting the preventing member, and a guide portion arranged on the base portion and including a guide surface that extends substantially along an angle relative to the bottom wall of the processing chamber and such that an inner portion of the guide surface is closer to the bottom wall of the processing chamber than an outer portion of the guide surface to prevent generation of a vortex over on the fixing member.

An outer-end of the guide portion may be substantially aligned with a top surface of the fixed body. The guide surface may be inclined. The guide surface may include a plurality of steps and may have a stair-like cross section. The guide surface may be curved. The preventing member may include a blocking portion and a support portion, and the support portion may include a plurality of protrusions extending outwardly from an outer surface of the blocking portion, and the fixing member may include a base that includes supporting grooves for respectively receiving the protrusions.

At least one of the above and other features and advantages of the present invention may be separately realized by providing a deposition-preventing member employable in a processing chamber of a deposition apparatus for processing a substrate removeably supplied to the deposition apparatus, the substrate including a to-be-blocked portion that is to be blocked during a deposition process, the deposition apparatus including a moveable supporting member a fixed body arranged between the moveable supporting member and a sidewall of the processing chamber, the deposition-preventing member including a fixing member for fixing the deposition preventing member to the fixed body of the processing chamber, a blocking member for blocking the to-be-blocked portion of the substrate to be processed, and a guiding member for guiding fluid and particles out from the processing chamber, the guiding member having a guiding surface that prevents a vortex from forming on the deposition-preventing member when fluid and particles, supplied or generated during processing, are flowing out of the processing chamber.

The guiding member may be at least one of an inclined surface and a curved surface. The guiding member may be arranged over the blocking member, and an outer end portion of the guiding member may be substantially aligned with an upper surface of the fixed body.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a cross-sectional view of a deposition apparatus according to one or more aspects of the invention;

FIG. 2 illustrates a top-plan view of an exemplary embodiment of a deposition-preventing member and an exemplary embodiment of a fixing member employable in the deposition apparatus illustrated in FIG. 1;

FIG. 3 illustrates an enlarged view of the dotted-circled ‘A’ portion illustrated in FIG. 1;

FIG. 4 illustrates a second embodiment of a fixing member employable by the deposition apparatus illustrated in FIG. 1;

FIG. 5 illustrates a third embodiment of a fixing member employable by the deposition apparatus illustrated in FIG. 1;

FIG. 6 illustrates flow of fluid inside a processing chamber in an apparatus employing a conventional fixing member; and

FIG. 7 illustrates flow of fluid inside a processing chamber in an apparatus employing a fixing member according to one or more aspects of the invention.

### DETAILED DESCRIPTION OF THE INVENTION

Korean Patent Application No. 2005-47870, filed on Jun. 3, 2006, in the Korean Intellectual Property Office, and entitled: “Deposition Apparatus,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when an element is referred to as being “on” another element, it can be directly on the other element, or intervening elements may also be present. Further, it will be understood that when an element is referred to as being “under” another element, it can be directly under, and one or more intervening elements may also be present. In addition, it will also be understood that when an element is referred to as being “between” two elements, it can be the only element between the two elements, or one or more intervening elements may also be present. Like reference numerals refer to like elements throughout.

While the embodiments of the present invention will be described in conjunction with a specific deposition apparatus, they will not be limited thereto and may be applied to other apparatuses where a process is performed by supplying process gas onto a wafer. Further, while the deposition apparatus will be described to have a configuration for performing a chemical vapor deposition (CVD) process, it may have a configuration for performing other processes, e.g., a sputtering process.

In the embodiments of the invention, a to-be-deposited region will be called a “deposit-yes region”, e.g., an edge of a wafer W, and a region where material is not to be deposited will be called a “deposit-no region”, e.g., a central region of the wafer W.

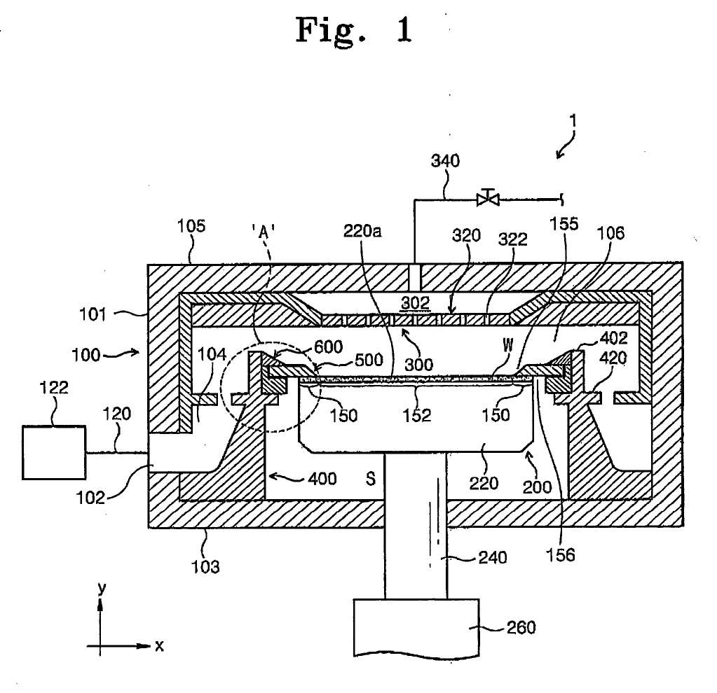

A deposition apparatus 1 employing one or more aspects of the invention is illustrated in FIG. 1. The deposition apparatus 1 may include a processing chamber 100, a supporting member 200, a gas supply member 300, a fixed body 400, a deposition-preventing member 500 and a fixing member 600. The processing chamber 100 may include a sealed space 106 therein. An exhaust pipe 120 may be connected to one wall, e.g., sidewall 101, of the processing chamber 100, and the exhaust pipe 120 may maintain a pressure of the processing chamber 100 at a set processing pressure and may forcibly suction by-products produced inside the processing chamber 100 outside of the sealed space 106. The exhaust pipe 120 may include a pump 122.

The supporting member 200 may be arranged within the processing chamber 100 and the supporting member 200 may support a semiconductor substrate, e.g., a wafer W, thereon. In embodiments of the invention, the supporting member 200 may be arranged at a lower portion of the processing chamber 100. The supporting member 200 may include a support plate 220 on which the wafer W may be loaded. The support plate 220 may be a disk-shaped member. The support plate 220 may hold a wafer W, which is being processed, by a mechanical mechanism, vacuum absorption, static electricity, etc. The supporting member 200 may include a heating device for maintaining a wafer W at a set processing temperature. For example, the support plate 220 may be a heating plate.

The support plate 220 may be connected to a driving mechanism 260 by a support leg 240. The support leg 240 may be moved, e.g., moved up and/or down and rotated, by the driving mechanism 260, so that a position of a wafer W may be adjusted within the processing chamber 100. The support leg 240 may have one end connected to a bottom of the support plate 220 and another end connected to the driving mechanism 260. A plurality of lift pins (not shown) may be provided for loading a wafer W, which may be transferred into the processing chamber 100 by means of a transfer arm (not shown), onto the support plate 220. The lift pins may be moveable, e.g., movable up and down.

To arrange a wafer W on the supporting member 200, the support plate 220 may be moved, e.g., moved downward, by the driving mechanism 260 via the support leg 240. The support plate 220 may be moved away, e.g., downward, such that a top surface 220a of the support plate 220 may be spaced apart from the deposition-preventing member 500. When the top surface 220a of the support plate 220 is spaced apart from the deposition-preventing member 500, a wafer W may be transferred to the support plate 220 via an inserting hole (not shown) of the processing chamber 100. The transferred wafer W may be loaded onto the support plate 220 by lift pins (not shown). The support plate 220 may then be moved, e.g., elevated, toward the deposition-preventing member until the deposition-preventing member 500 contacts and/or comes close to the transferred wafer W. In embodiments of the invention, the support plate 220 may have a fixed position and the deposition-preventing member 500 may be moveable. In embodiments of the invention, both the support plate 220 and the deposition-preventing member 500 may be moveable.

The gas supply member 300 may supply process gas into the processing chamber 100. In embodiments of the invention, the gas supply member 300 may include an injecting plate 320. The injecting plate 320 may be arranged within the processing chamber 100. In embodiments, the injecting plate 320 may be arranged at, e.g., an upper portion of the processing chamber 100 and may overlap the support plate 220. The injecting plate 320 may be spaced apart from a top wall 105 of the processing chamber 100. A gas introducing space 302 may be defined between injecting plate 320 and the top wall 105 of the processing chamber 100. The injecting plate 320 may include a plurality of injection holes 322. The process gas flowing into the gas introducing space 302 may be injected toward a wafer W, e.g., downward, through the plurality of injection holes 322. A supply pipe 340 may be connected to the gas introducing space 302. The supply pipe 340 may supply process gas including, e.g., deposition gas, from an external gas source (not shown) into the gas introduce space 302.

As discussed above, portions of a wafer W may need to be covered and/or protected during processing. During, e.g., a deposition process, deposit-no regions may be protected by, e.g., a deposition-preventing member 500 to prevent the deposition of materials on the deposit-no regions. For example, edges 156, e.g., beveled portions, of a wafer W may be protected during a deposition process such that formation of a thin film that may generate undesired or contaminant particles during subsequent handling and/or processing may be reduced and/or prevented.

FIG. 1 illustrates an exemplary deposit-no region 150, e.g., an edge of a wafer W, an exemplary deposit-yes region 152, e.g., a central portion of the wafer W, and a boundary 155 between the deposit-no region 150 and the deposit-yes region 152. The deposition-preventing member 500 may cover the deposit-no region 150 and may expose the deposit-yes region 152 to the gas supply member 300.

As shown in FIG. 1, the fixed body 400 may be provided within the processing chamber 100 and between the supporting member 200 and the sidewall 101 of the processing chamber 100. The fixed body 400 may surround the supporting member 200 such that when the supporting plate 220 is moved to be in direct contact or indirect contact, e.g., via a wafer W placed thereon, with the deposition-preventing member 500, a combination of the fixed body 400, the deposition preventing member and the supporting plate 220 substantially and/or completely prevents materials from entering a space S between a bottom wall 103 of the processing chamber and the top surface 200a of the supporting member 200, the fixing member 600 and the fixed body 400. The fixed body 400 may define a flow path 104 between the fixed body 400 and the sidewall 101 of the processing chamber 100. Materials, e.g., fluid, that have flowed through the flow path 104 defined in the processing chamber 100 may be exhausted to the outside of the processing chamber 100 and the deposition apparatus 1 via the exhaust pipe 120. A top surface 402 of the fixed body 400 may be positioned higher along the y-axis than a top surface of the deposition-preventing member 500. The fixed body 400 may include supporting projections 420 for supporting the fixing member 600. The supporting projections 420 may project inward from an inner sidewall of the fixed body 400.

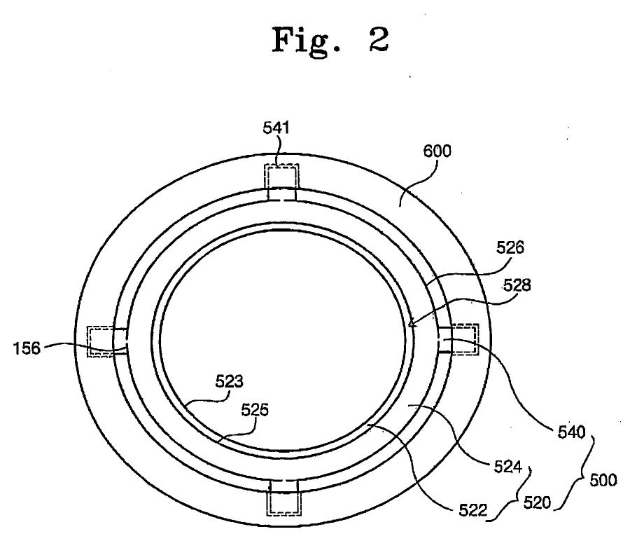

FIG. 2 illustrates a top-plan view of an exemplary embodiment of the deposition-preventing member 500 and an exemplary embodiment of the fixing member 400 according to one or more aspects of the invention. The deposition-preventing member 500 may include a blocking portion 520 and a supporting portion 540. The blocking portion 520 and the supporting portion 540 may be integrally formed. In embodiments of the invention in which the deposit-no regions 150 correspond to an edge of a wafer W, the blocking portion 520 may have a ring-like shape. The blocking portion 520 may overlap and/or block the deposit-no region 150, e.g., the edge, of the wafer W being processed and may expose the deposit-yes region 152, e.g., the central portion, of the wafer W being processed.

As shown in FIG. 2, the blocking portion 520 may include an inner portion 522, e.g., a portion further from sidewalls 101 of the processing chamber 100 and an outer portion 524, e.g., a portion closer to sidewalls 101 of the processing chamber 100. The inner portion 522 and the outer portion 524 may be integrally formed. The inner portion 522 and the outer portion 524 may connect at a boundary 525.

The inner portion 522 of the blocking portion 520 may have an inner boundary 523. In embodiments of the invention, when the deposition-preventing member 500 is arranged in the processing chamber 100, the inner boundary 523 may be aligned with a boundary 155 between the deposit-no region 150 and deposit-yes region 152 of the wafer W.

The outer portion 524 of the blocking portion 520 may have an outer boundary 526. In embodiments of the invention, when the deposition-preventing member 500 is arranged in the processing chamber 100, the outer boundary 526 may be aligned with and/or extend further outward from an edge 156 of the wafer W being processed.

The supporting portion 540 of the deposition-preventing member 500 may correspond to a plurality of projections 541 that protrude outward from the outer boundary 526 of the blocking portion 520. The supporting portion 540 may be used to fix the deposition-preventing member 500 at a determined position in the processing chamber 100. The supporting portion 540 may include any number, e.g., three, five, eight, projections 541 and the projections 541 may be spaced at regular intervals. In embodiments employing such a deposition-preventing member 500, process gas injected toward the deposit-no region 150, e.g., the edge, of the wafer W may be deposited onto the deposition-preventing member 500.

In embodiments of the invention, the inner portion 522 may have an angled surface 528, which may be arranged such that the inner boundary 523 at a lower point along the y-axis than the boundary 525 between the inner portion 522 and the outer portion 524 of the blocking member 520. In embodiments of the invention, the inner portion 522 may have a triangular-like cross section along an x-y plane. The outer portion 524 may have a substantially constant thickness along the y-axis and may have a substantially rectangular cross-section along the x-y plane. In embodiments of the invention, when fluid flows outward from the processing chamber 100, the fluid flowing from the central portion of the wafer W to the edge(s) of the wafer W may be guided by the angled surface 528 to flow over the blocking member 520 and generation of a vortex from fluid 520 colliding with the deposition-preventing member 500 may be prevented.

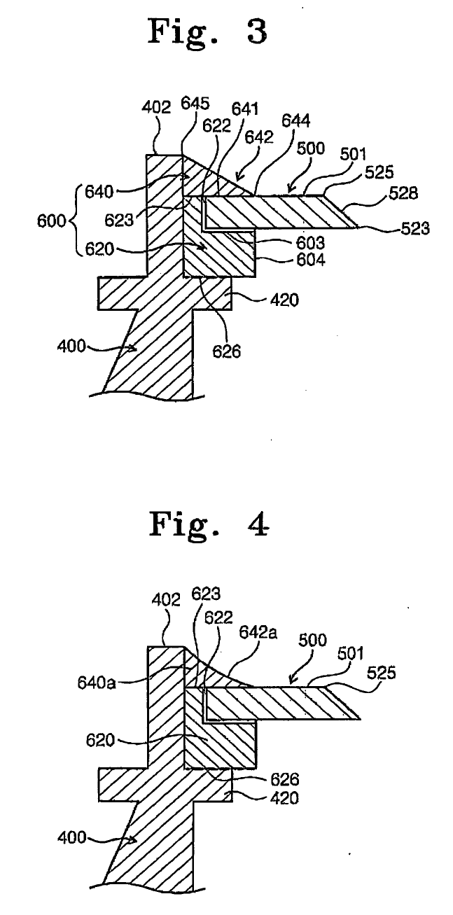

FIG. 3 illustrates an enlarged view of the dotted-circled ‘A’ portion illustrated in FIG. 1. The fixing member 600 may include a base 620 and a guide portion 640. The base 620 may be a ring-shaped block, which may be mounted on the supporting projections 420 of the fixed body 400. The base 620 may define a supporting groove 622 for receiving a corresponding portion of the deposition-preventing member 500. The supporting groove(s) 622 may be formed at, e.g., a top portion of the base 620. The protrusions 541 of the support portion 540 of the deposition-preventing member 500 may be received by, e.g., inserted into, the supporting grooves 622, respectively. In embodiments of the invention, a number of the supporting grooves 622 may equal a number of the protrusions 541 of the support portion 540. When the deposition-preventing member 500 is attached to the fixing member 600, a top surface 501 of the deposition-preventing member 500 may be substantially aligned with a top surface 623 of the base 620 of the fixing member 600. A width of the supporting groove 622 along the y-direction may be defined by a groove-surface 603 of the base 620 and a bottom surface 641 of the guide portion 640. A shape of the supporting groove 622 may be defined by the combination of respective surfaces of the guide portion 640 and the base 620, and may correspond to a shape of the supporting portion 540 of the deposition-preventing member 500.

The top surface 623 and a bottom surface 626 of the base 620 may be substantially planar, and may substantially extend along the x-direction. The base 620 may have a substantially L-shaped cross-section along the x-y plane based on the shape of the supporting groove 622. The top surface 623 of the base 620 may be arranged at a lower level along the y-axis than the top surface 402 of the fixed body 400 such that a step-like relationship may exist between the top surface 623 of the base 620 and the top surface 402 of the fixed body 400. An L-shaped boundary may be formed between the top surface 623 of the base 620 and a sidewall portion of the fixed body 400 extending between the top surface 402 of the fixed body 400 and the top surface 623 of the base 620.

Without the guide portion 640, due to the step difference between the top surface 623 of the base 620 and the top surface 402 of the fixed body 300, a vortex may be generated in the processing chamber 100 during, e.g., a processing step or a processing chamber 100 cleaning operation. In embodiments of the invention, the guide portion 640 is provided to prevent and/or reduce the generation of a vortex at, e.g., the boundary between the top surface 623 of the base 620 and the fixed body 400.

The guide portion 640 may be a ring-shaped block, which may be arranged on base 620. The guide portion 640 may be arranged on the top surface 623 of the base 620. A bottom surface 641 of the guide portion 640 have a substantially same shape, e.g., planar, as the top surface 623 of the base 620. An inner boundary 644 of the bottom surface 641 may be substantially aligned with an inner boundary 604 of the base. As discussed above, the shape of the supporting groove 622 may be defined by the combination of respective surfaces of the guide portion 640 and the base 620 and may correspond to a shape of the supporting portion 540 of the deposition-preventing member 500.

The guide portion 640 may include a guide surface 642, which may be angled. The guide surface 642 may be angled such that the guide surface 642 extends downward from the top surface 402 of the fixed body 400 toward the inner boundary 644 of the guide portion 640. The inner boundary 644 may correspond to where the guide surface 642 meets the bottom surface 641 of the guide portion 640. An outer boundary 645 of the guide portion 640 may be aligned with the top surface 402 of the fixed body 400. In embodiments of the invention, the outer boundary 645 may extend further up along the y-direction than the top surface 402 of the fixed body 400. The guide portion 640 and/or the base 620 may include engaging members, e.g., grooves or protrusions, (not shown) for attaching the guide portion 640 to the base 620.

In embodiments of the invention, e.g., the exemplary embodiment illustrated in FIG. 3, the guide portion 640 of the fixing member 600 may have a substantially planar guide surface 642. The guide portion 640 may have a substantially right-angled triangular cross-section along the x-y plane.

FIG. 4 illustrates a second exemplary embodiment of the fixing member 600. In this exemplary embodiment, the fixing member 600 includes a guide portion 640a, which may have a curved guide surface 642a, as illustrated in FIG. 4. A tangential angle to the guide surface 642a may increases outwardly so that fluid may smoothly flow from an interior portion of the guide surface 642a to an exterior portion of the guide surface 642a.

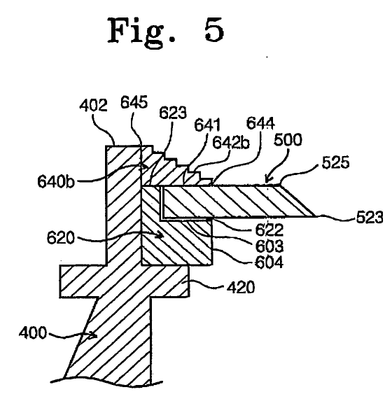

FIG. 5 illustrates a third embodiment of the fixing member 600. In this exemplary embodiment, the fixing member includes a guide portion 640b, which may have a guide surface 642b including a plurality of step, as illustrated in FIG. 5. The guide portion 640b may have a substantially right-angle triangular cross section with the hypotenuse of the triangle having a stair-like shape. The inner-most step may be the lowest step along the y-axis and the outer-most step may be the highest step along the y-axis.

In embodiments of the invention, the guide portion 640, 640a, 640b, may be fabricated separately from the base 620 and the guide portion 640, 640a, 640b may be attached to the base 620 in, e.g., the processing chamber 100. In embodiments of the invention, the guide portion 640 and the base 620 may be fabricated as one body. In the above description of exemplary embodiments, the exhaust pipe 120 and the fluid path 104 are provided on the sidewall 101 of the processing chamber 100, however, the fluid path 104 may be provided between the sidewall 101 of the processing chamber 100 and the fixed body 400 and the exhaust pipe 120 may be provided at the bottom wall 103 of the processing chamber 100.

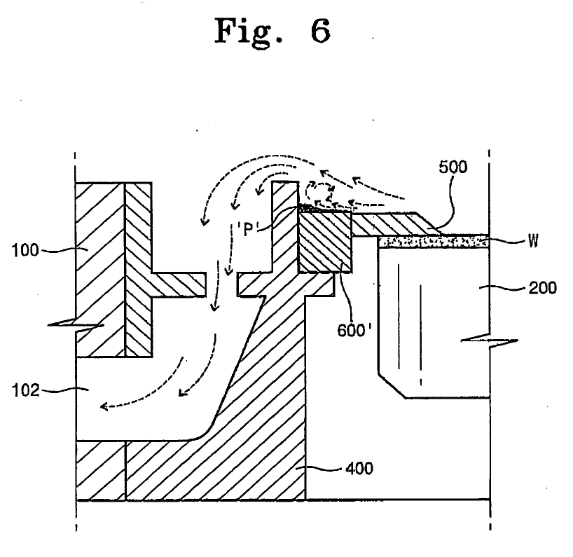

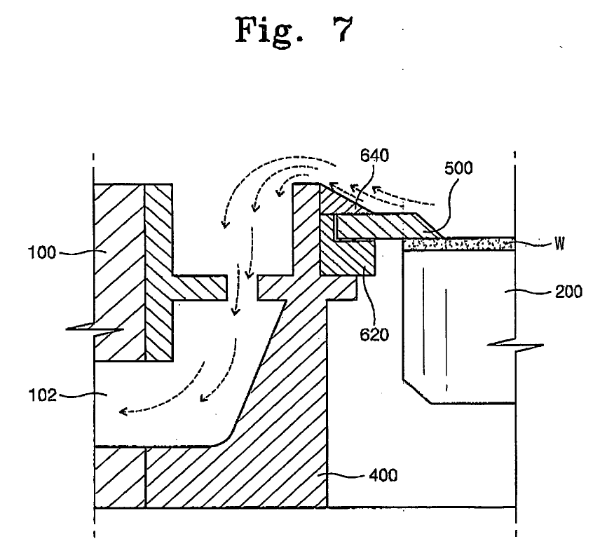

FIG. 6 illustrates flow of fluid inside a processing chamber 100 in an apparatus employing a conventional fixing member 600′ having, e.g., a horizontal top surface, and FIG. 7 illustrates flow of fluid inside a processing chamber 100 in an apparatus employing a fixing member 600 according to one or more aspects of the invention and having an include guide surface, e.g., 642, 642a, 642b.

Inside a processing chamber, fluid may flow outward toward, e.g., a fixed body from an inner side of a fixing member, e.g., from the central region of a wafer. When the conventional fixing member 600′, having the horizontal top surface, is employed, as shown in FIG. 6, fluid flowing along the top surface of the fixing member 600′ may run against a sidewall of a fixed body 400 and generate a vortex at a boundary between the fixed body 400 and the fixing member 600′. Deposition gas or reactive byproducts flowing along the fluid may be deposited on the top surface of the fixing member 600′ (see ‘P’ of FIG. 6), serving as particles in subsequent processes. When the inside of the processing chamber 100 is cleaned, the vortex may also be generated at the boundary between the fixed body 400 and the fixing member 600′. Thus, the resulting cleaning quality may be degraded at, e.g., the top surface of the fixing member 600′. As a result, additional time may be required to clean the processing chamber 100.

However, as shown in FIG. 7, when a processing chamber 100 employing a fixing member 600 according to one or more aspects of the invention is employed, the guide portion 640 may have a guide surface, e.g., 642, 642a, 642b that may be inclined such that fluid may flow along the guide surface 642, 642a, 642b of the fixing member 600 to prevent generation of a vortex. Thus, the fluid may smoothly flow outward beyond the fixing member 600 and the fixed body 400. Embodiments of the invention help reduce and/or prevent the deposition of deposition gas and/or reactive by-products on, e.g., the top surface of, the fixing member 600 and shorten a time required for cleaning the inside of a processing chamber.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A deposition apparatus for processing a substrate removeably supplied to the deposition apparatus, the substrate including a to-be-blocked portion that is to be blocked during a deposition process, the deposition apparatus comprising:
a processing chamber to which an exhaust pipe is connected;
a supporting member arranged inside the processing chamber for holding the substrate;
a gas supply member for supplying process gas to the substrate held by the supporting member;
a deposition-preventing member arranged to cover the to-be-blocked portion of the substrate to block the process gas from being supplied to the to-be-blocked portion of the substrate; and
a fixing member disposed to support the deposition-preventing member,
wherein a top surface of the fixing member includes a guide surface that extends substantially along an angle relative to a bottom wall of the processing chamber and such that an inner portion of the guide surface is closer to the bottom wall of the processing chamber than an outer portion of the guide surface.

2. The deposition apparatus as claimed in claim 1, wherein the guide surface is inclined.

3. The deposition apparatus as claimed in claim 1, wherein the guide surface includes a plurality of stepped surfaces.

4. The deposition apparatus as claimed in claim 1, wherein the guide surface is curved.

5. The deposition apparatus as claimed in claim 1, wherein the fixing member is spaced apart from a sidewall of the processing chamber to define a path between the sidewall of the processing chamber and the fixing member for fluid, which is supplied to or generated during inside the processing chamber during processing, to flow to the exhaust pipe.

6. The deposition apparatus as claimed in claim 1, wherein the deposition-preventing member comprises a blocking portion and a support portion, the support portion including a plurality of protrusions extending outwardly from an outer surface of the blocking portion, and
the fixing member includes a base that includes supporting grooves for respectively receiving the protrusions.

7. The deposition apparatus as claimed in claim 1, wherein the deposition-preventing member comprises a blocking portion and a support portion, the support portion including a plurality of protrusions extending outwardly from an outer surface of the blocking portion, and
the fixing member includes a base portion and a guide portion that together define a plurality of supporting grooves for respectively receiving the protrusions, wherein the guide portion is arranged on the base portion and the guide portion includes the guide surface.

8. The deposition apparatus as claimed in claim 7, wherein the guide portion is attachable to and detachable from the base portion.

9. The deposition apparatus as claimed in claim 1, wherein the deposition-preventing member and the fixing member are substantially ring-like members.

10. The deposition apparatus as claimed in claim 1, wherein the fixing member surrounds sides of the supporting member such that a surface of the supporting member on which the substrate is arranged is exposed and capable of receiving the process gas.

11. The deposition apparatus as claimed in claim 1, wherein the deposition-preventing member blocks an edge portion of the substrate being processed during the deposition process.

12. An apparatus for depositing a thin-film on a semiconductor substrate removeably supplied to the apparatus, the substrate including a to-be-blocked portion that is to be blocked during formation of the thin-film, the apparatus comprising:
a processing chamber to which an exhaust pipe is connected;
a supporting member disposed inside the processing chamber for holding the substrate;
a gas supply member for supplying process gas onto the substrate held by the supporting member;
a preventing member arranged to cover the to-be-blocked portion of the substrate to prevent the process gas from being supplied to the to-be-blocked portion of the substrate;
a fixed body disposed between the supporting member and a sidewall of the processing chamber, the fixed body being spaced apart from the sidewall of the processing chamber and defining a path, between the sidewall of the processing chamber and the fixed body, along which fluid supplied to or generated inside the processing chamber may flow to be exhausted, the fixed member extending further from a bottom wall of the processing chamber than the preventing member and the fixed member including a projecting support portion; and
a fixing member arranged on the projecting support portion, the fixing member including:
a base portion for supporting the preventing member, and
a guide portion arranged on the base portion and including a guide surface that extends substantially along an angle relative to the bottom wall of the processing chamber and such that an inner portion of the guide surface is closer to the bottom wall of the processing chamber than an outer portion of the guide surface to prevent generation of a vortex over on the fixing member.

13. The apparatus as claimed in claim 12, wherein an outer-end of the guide portion is substantially aligned with a top surface of the fixed body.

14. The apparatus as claimed in claim 12, wherein the guide surface is inclined.

15. The apparatus as claimed in claim 12, wherein the guide surface includes a plurality of steps and has a stair-like cross section.

16. The apparatus as claimed in claim 12, wherein the guide surface is curved.

17. The apparatus as claimed in claim 12, wherein the preventing member comprises a blocking portion and a support portion and the support portion includes a plurality of protrusions extending outwardly from an outer surface of the blocking portion, and
the fixing member includes a base that includes supporting grooves for respectively receiving the protrusions.

18. A deposition-preventing member employable in a processing chamber of a deposition apparatus for processing a substrate removeably supplied to the deposition apparatus, the substrate including a to-be-blocked portion that is to be blocked during a deposition process, the deposition apparatus including a moveable supporting member a fixed body arranged between the moveable supporting member and a sidewall of the processing chamber, the deposition-preventing member including:
fixing means for fixing the deposition preventing member to the fixed body of the processing chamber;
blocking means for blocking the to-be-blocked portion of the substrate to be processed; and
guiding means for guiding fluid and particles out from the processing chamber, the guiding means having a guiding surface that prevents a vortex from forming on the deposition-preventing member when fluid and particles, supplied or generated during processing, are flowing out of the processing chamber.

19. The deposition-preventing member of claim 18, wherein the guiding means is at least one of an inclined surface and a curved surface.

20. The deposition-preventing member of claim 18, wherein the guiding means is arranged over the blocking means and an outer end portion of the guiding means is substantially aligned with an upper surface of the fixed body.
